(19) United States
(12) Patent Application Publication
(10) Pub. No.: US 2005/0151473 A1
(43) Pub. Date: Jul. 14, 2005

(54) Method for fabricating rear plate of plasma display panel and rear plate fabricated thereby

(76) Inventors: Hsiang-Wen Wan, Sanchong City (TW); Wen-Fa Sung, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/858,028

(22) Filed: Jun. 1, 2004

(30) Foreign Application Priority Data
Jan. 9, 2004 (TW) 93100523

(51) Int. Cl. H01J 17/49

(52) U.S. Cl. 313/582

(57) ABSTRACT

The present invention provides a method for fabricating a rear plate of a plasma display panel. A plurality of address electrodes is disposed on a rear substrate. A dielectric layer is then formed on the surface of the substrate, covering all of the address electrodes. A rib structure defining the surface of the dielectric layer into a plurality of units and a phosphor alignment structure are formed by a rib process. A Phosphor application is performed by way of the phosphor alignment structure to fill red, blue and green phosphors into the units sequentially, resulting finally in a rear plate of a plasma display panel.

### BACKGROUND OF THE INVENTION

1. Field of the Invention

The present invention relates to a plasma display panel and in particular to alignment structures of a rear substrate of a plasma display panel.

2. Description of the Related Art

A plasma display panel (PDP) typically has a large viewing area. The luminescent principle of the PDP is the same as that of fluorescent lamps. A vacuum glass trough is filled with inert gas. When a voltage is applied to the glass trough, plasma is generated and radiates ultraviolet (UV) rays. The fluorescent material coated on the wall of the glass trough adsorbs the UV rays, such that the fluorescent material radiates visible light including red, green and blue light. The plasma display comprises a combination of hundreds of thousands of illuminating units, each having three subunits for g red, green, and blue light, respectively. Images are displayed by mixing primary colors.

Typically, three steps are required in fabrication a PDP. A front end process fabricates a front substrate, including transparent electrodes, bus electrodes, and a protecting layer. A front end process then fabricates a rear substrate structure, including address electrodes, rib barriers, and phosphor layers. Finally, the front substrate and the rear substrate are aligned, combined, and injected with gas to a predetermined pressure for discharge. Finally, the PDP is inspected by checking the discharge reliability of each discharge cell.

In general, transparent and non-transparent bus electrodes are formed on the front substrate, of Indium-Tin-Oxide (ITO) and metals such as Cr—Cu alloy respectively. A dielectric layer and a protecting layer are deposited in sequence to cover the electrodes.

Typically, in the fabrication of the rear substrate structure, address electrodes are formed before the ribs. FIG. 1A is a top view of conventional rear substrate structure of a PDP. As shown in FIG. 1A, ribs 130 on the substrate 110 forms a plurality of grid-shaped discharge cells. Red, blue, and green phosphors (140R, 140B, and 140G) are applied on the corresponding discharge cells respectively. Address electrodes 120 are interposed between the ribs 130 and the substrate 110 substantially at the center of each discharge cell. Three prime color phosphors are coated by way of alignment structures 150 formed at the same time as the address electrodes 120.

FIG. 1B is a cross section along line 1-1 of FIG. 1A. Typically, address electrodes 120 are formed before discharge cells, and the alignment structures 150 are formed in the corner of a non-display area at the same time as address electrodes 120. The address electrodes 120 are then covered by a dielectric layer 125. The alignment structures are circular or rectangular. The ribs 130 on the dielectric layer 125 form a plurality of discharge cells. Three prime color phosphors (140R, 140B, and 140G) are coated into the sidewalls and surface of each corresponding discharge cell respectively to create three prime colour discharge cells, wherein three adjacent red, blue and green discharge cells form a pixel. Finally, the front substrate and the rear substrate are combined and sealed to create a plasma display panel.

Typically, each discharge cell is coated with only one color. However, as shown in FIGS. 1A and 1B, one discharge cell can be coated with two different color phosphors when misalignment occurs during the coating process, such that the colors are mixed when the cells are discharged, producing non-uniform color and color shift problems, and display quality of the PDP is affected.

### SUMMARY OF THE INVENTION

Accordingly, an object of the invention is to provide a fabricating method and structure for phosphor alignment on a rear substrate with improved alignment between coated phosphors and ribs.

To achieve the above objects, the present invention provides a method for fabricating a rear substrate structure of a plasma display panel, comprising the following steps. A plurality of address electrodes are formed on a substrate. A dielectric layer is formed on the address electrodes and the substrate. A rib structure and an alignment structure are formed on the dielectric layer, whereby the rib structure defines a plurality of discharge cells. Phosphors are coated into corresponding discharge cells with a coating apparatus oriented by the alignment structure.

The present invention also provides a structure of a rear substrate structure of a plasma display panel. A plurality of address electrodes are on the substrate, and a dielectric layer covers the address electrodes and the substrate. A rib structure on the substrate defines a plurality of discharge cells, and phosphor alignment structure is disposed on the dielectric layer, wherein the phosphor alignment structure is formed at the same time as the rib structure. Red, blue, and green phosphors are disposed in corresponding discharge cells.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a top view of a conventional rear substrate structure of a PDP;

FIG. 1B is a cross section along line 1-1 of FIG. 1A;

FIG. 2A˜FIG. 2F illustrate the fabrication of a rear substrate structure of a PDP in accordance with the invention;

FIG. 3A˜FIG. 3C illustrate problems which may occur in conventional technology;

FIG. 4A and FIG. 4B illustrate the alignment structure of the invention.

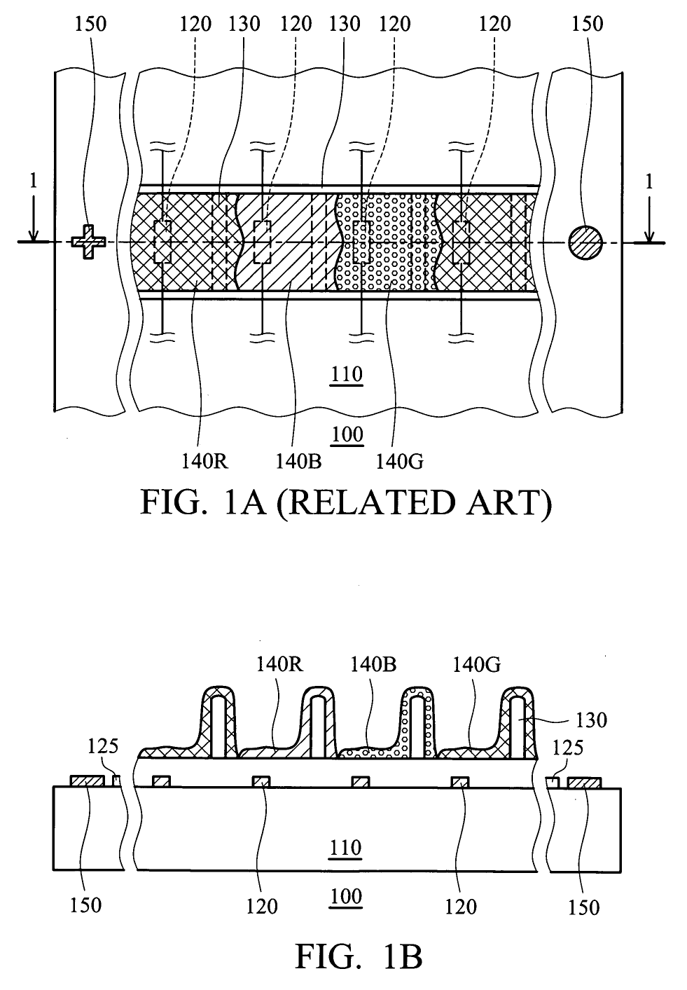

### DETAILED DESCRIPTION OF THE INVENTION

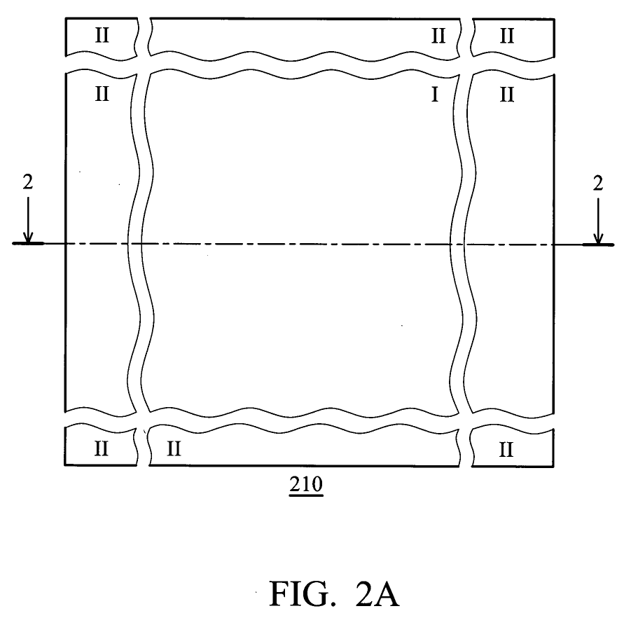

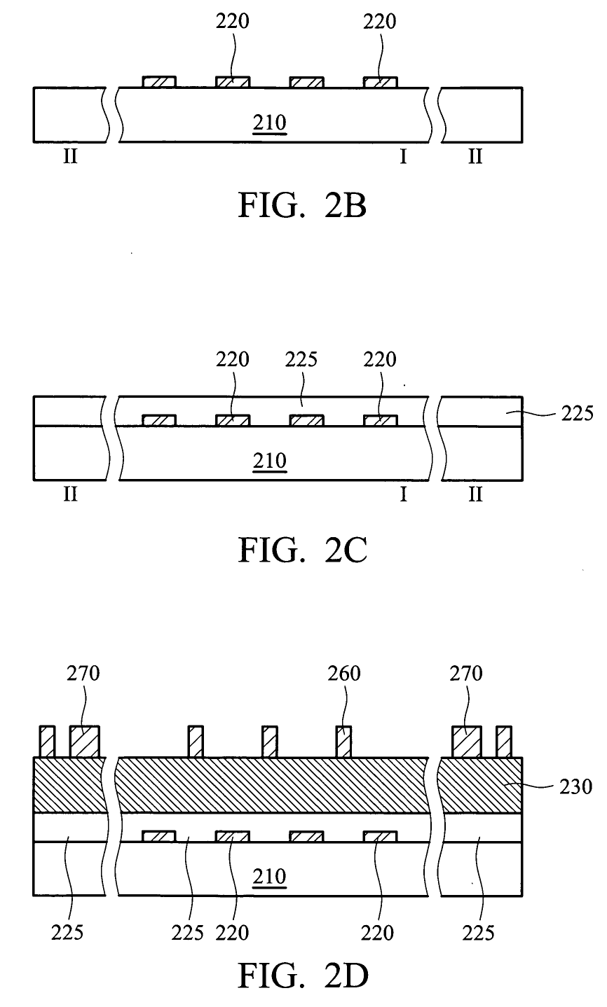

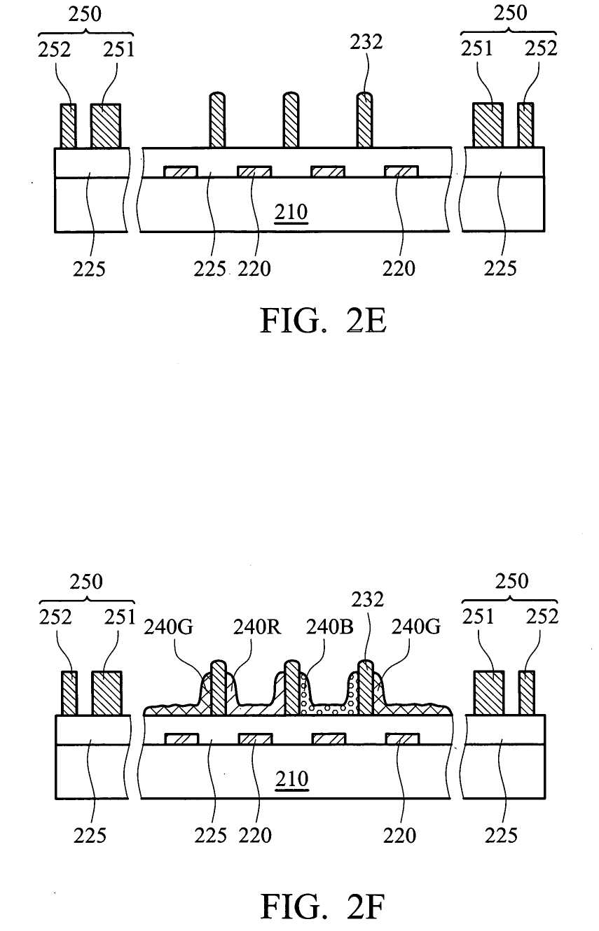

FIGS. 2A˜2F illustrate the fabrication of a rear substrate structure of a PDP in accordance with the invention. FIG. 2A is a top view of a rear substrate structure of a PDP. Typically, the internal area I of the surface of the rear substrate is a display area, and the periphery area II a non-display area. Preferably, alignment structures for phosphor coating are disposed on the non-display area II so as to not affect displayed.

FIGS. 2B˜2F are cross sections along line 2-2 of FIG. 2A. In FIG. 2B, a plurality of address electrodes 220 are on a rear substrate 210, which can be glass. Photographic thick film process can be applied to form address electrodes 220, in which the same can be formed by photo lithography and firing thereby. The firing temperature is around 500° C.˜550° C. The address electrodes 220 are conductive materials, such as Ag, photo-sensitive macromolecule or glass frit.

As shown in FIG. 2C, a dielectric layer 225 is formed by, for example screen-printing, on the rear substrate 210 and the address electrodes 220 at thickness less than 30 μm, and the dielectric layer 225 then fired over 500° C., to protect address electrodes 220 thereunder.

As shown in FIG. 2D, a rib layer 230 of a predetermined thickness is coated on the dielectric layer 225. A rib mask 260 and an alignment mask 270 are formed on the rib layer 230, in which the rib mask 260 is disposed in the display area I and the alignment mask 270 in the non-display area II. Next, sandblasting is performed using the masks 260 and 270 as sandblasting resistance. Accordingly, exposed rib layer 230 is removed to form ribs 232 and alignment structures 250. After removal of remaining masks 260 and 270 and sintering of the ribs 232, as shown in FIG. 2E, the ribs 232 define a plurality of cells on the display area I, each of which includes a corresponding address electrode 220 thereunder. The alignment structures are formed in the non-display area II for aligning when coating phosphor. Preferably, each alignment structure 250 comprises an alignment mark 251 and a protecting structure 252.

Referring to FIG. 2F, a phosphor-coating apparatus is oriented by the alignment structure 250, and phosphors are coated into corresponding discharge cells. In detail, a screen printing apparatus is oriented by the alignment mark 251 of the alignment structure, and the discharge cells are filled with corresponding red, blue or green phosphors (240R, 240G, and 240B) to form prime color discharge cells.

The alignment structures are formed at the same time as the ribs, unlike the conventional technology, in which alignment structures are formed at the same time as the address electrodes. High temperature sintering process is avoided when forming address electrodes, the dielectric layer and the ribs. Consequently, shrinkage and deformation of the alignment marks are eliminated, avoiding color mixing from misalignment.

In a preferred embodiment, for protecting the alignment marks 251, each alignment structure 250 comprises an alignment mark 251 and a protecting structure 252, in which each alignment mark 251 is substantially surrounded by a protecting structure 252.

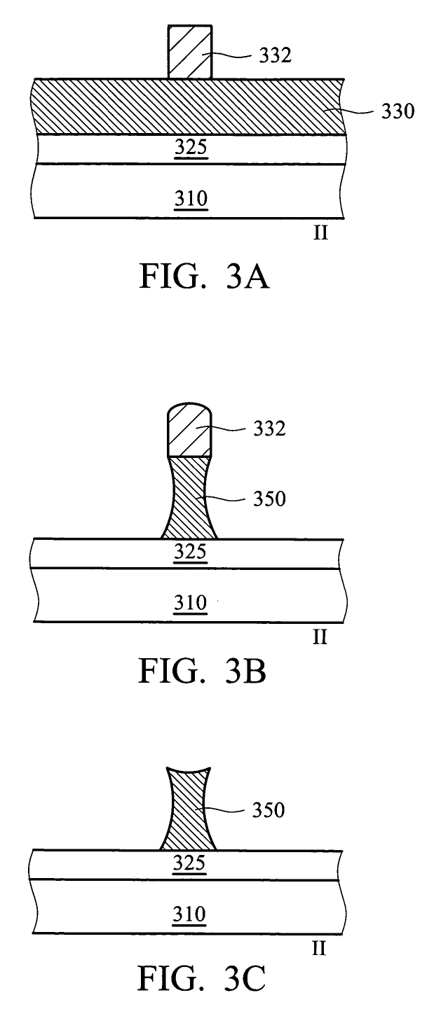

FIGS. 3A˜3C illustrate the problems which may be caused without a protecting structure 350. As shown in FIG. 3A, a dielectric layer 325 and a rib layer 330 are formed on the substrate 310 in sequence. Sandblasting resistance 332 is formed on the rib layer 330. As shown in FIG. 3B, sandblasting uses the sandblasting resistance 332 as a mask when removing the exposed portion of the rib layer 330, forming an alignment structure 350. Unlike the ribs in the display area, the alignment structure 350 on the non-display area is isolated. Consequently, sidewalls of the alignment structure 350 are prone to be over etched. As shown in FIG. 3C, after removal of the sandblasting resistance 332, the rib layer 330 forms a tip on the top when sintering, affecting the sealing between the front substrate and the rear substrate. Noise may be generated with faulty sealing. In order to avoid generating the described tip, a dummy protecting structure 252 is disposed adjacent to the alignment mark 251 during sandblasting process.

Preferably, the alignment mark 251 and the protecting structure 252 are spaced over at least 20 μm, enable clear formation and profiling thereof, and less than 500 μm to enable the protection of the alignment mark 251 by the protecting structure 252. The distance may vary with sandblasting, such that it is not limited in the invention.

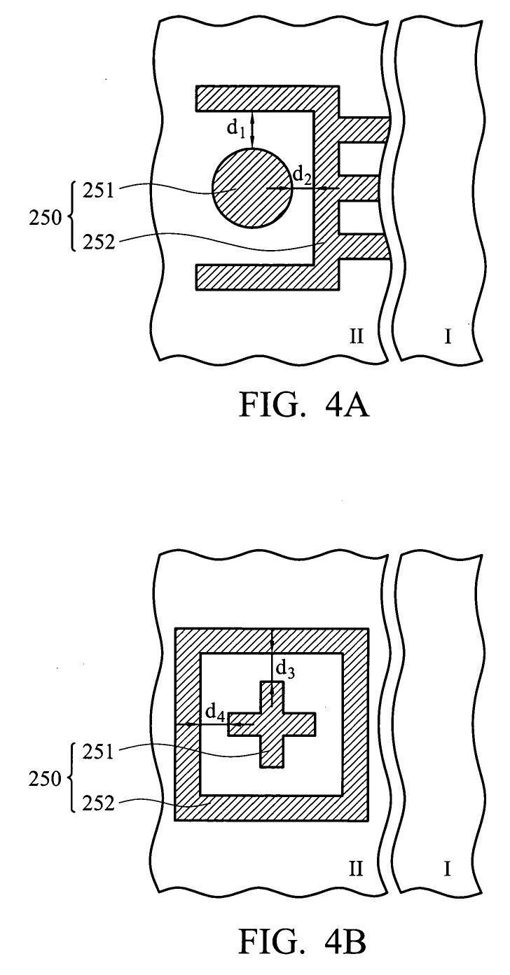

FIG. 4A and FIG. 4B illustrate the alignment structure of the invention. As shown in FIG. 4A, an alignment structure 250 comprises a circular alignment mark 251 shielded by a u-shaped protecting structure 252, and separated thereof by 20 μm˜500 μm. A preferable distance is around 70 μm.

As shown in FIG. 4B, an alignment structure 250 comprises a cross-shaped alignment mark 251 at the center of a hollow-square protecting structure 252, separated by 20 μm˜500 μm, and preferably, by around 70 μm.

The shape of the alignment mark 251 and the protecting structure 252 can vary according the precision of the alignment device of the screen printing apparatus, and not limited to those shown in FIG. 4A and FIG. 4B.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of thee appended claims should be accorded the broadest interpretation so as to encompass all such modifications and similar arrangements.

1. A method for fabricating a rear substrate structure of a plasma display panel, comprising:
forming a plurality of address electrodes on a substrate;
forming a dielectric layer on the substrate and the address electrodes;
forming a rib structure and an alignment structure on the dielectric layer, defining a plurality of discharge cells on the dielectric layer; and
coating phosphor into corresponding discharge cells with a coating apparatus oriented by the alignment structure.

2. The method as claimed in claim 1, wherein the alignment structure is formed in a non-display area of the substrate.

3. The method as claimed in claim 1, wherein the alignment structure comprises an alignment mark and a protecting structure, and the alignment mark is substantially surrounded by the protecting structure.

4. The method as claimed in claim 3, wherein the alignment mark is circular and the protecting structure is U-shaped or a hollow square.

5. The method as claimed in claim 3, wherein the alignment mark is cross-shaped and the protecting structure is U-shaped or a hollow square.

6. The method as claimed in claim 3, wherein the protecting structure is spaced from the alignment structure by 20 μm˜500 μm.

7. The method as claimed in claim 3, wherein formation of a rib structure and an alignment structure further comprises:
coating an isolating layer on the dielectric layer;
forming a sandblasting resistance isolating layer; and
sandblasting the isolating layer using the sandblasting resistance as a mask, and removing the uncovered isolating layer until the dielectric layer is exposed to form the rib structure and the alignment structure.

8. A structure of a rear substrate structure of a plasma display panel, comprising:
a substrate;
a plurality of address electrodes disposed on the substrate;
a dielectric layer covering the substrate and the address electrodes;
a rib structure on the substrate, defining a plurality of discharge cells;
a phosphor alignment structure disposed on the dielectric layer, wherein the phosphor alignment structure is formed at the same time as the rib structure; and
red, blue, and green phosphors disposed on corresponding discharge cells.

9. The structure as claimed in claim 8, wherein the phosphor alignment structure is disposed on a non-display area of the substrate.

10. The structure as claimed in claim 9, wherein the alignment structure comprises an alignment mark and a protecting structure, and the alignment mark is substantially surrounded by the protecting structure.

11. The structure as claimed in claim 10, wherein the alignment mark is circular and the protecting structure is U-shaped or a hollow square.

12. The structure as claimed in claim 10, wherein the alignment mark is cross-shaped and the protecting structure is U-shaped or a hollow square.

13. The structure as claimed in claim 10, wherein the protecting structure is spaced from the alignment structure by 20 μm˜500 μm.
